(19) United States
(12) Patent Application Publication
(10) Pub. No.: US 2005/0114663 A1
(43) Pub. Date: May 26, 2005

(54) Secure network access devices with data encryption

(75) Inventors: Kevin S. Cornell, Santa Cruz, CA (US); Paul Gentieu, Sunnyvale, CA (US); Arthur M. Lawson, Morgan Hill, CA (US); Stephen C. Gordy, Sunnyvale, CA (US); Lucy Hosking, Santa Cruz, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 10/975,309

(22) Filed: Oct. 28, 2004

Related U.S. Application Data
(60) Provisional application No. 60/524,216, filed on Nov. 21, 2003.

(51) Int. Cl. H04L 9/00

(52) U.S. Cl. 713/168

(57) ABSTRACT

Secure point to point network communications. Secure point to point network communications are accomplished by sending data across a secure link. Trusted partners at the link are matched to each other. To ensure that no un-trusted partners are on the link, authentication is performed. One of the points may be a secure tap. The secure tap authenticates a trusted partner by receiving a hardware embedded encryption key or value derived from the hardware embedded encryption key from the trusted partner. Data sent on the trusted link is encrypted to prevent interception of the data. The secure tap polices the link to ensure that no un-trusted partners are attached to the link and that the trusted partner is not removed from the link. If un-trusted partners are added to the link or trusted partners removed from the link, the secure tap ceases sending data.

### CROSS REFERENCE TO RELATED APPLICATIONS

This application claims the benefit of U.S. Provisional Application No. 60/524,216, filed Nov. 21, 2003 titled “Secure Network Access Devices With Data Encryption,” which is incorporated herein by reference.

### BACKGROUND OF THE INVENTION

1. The Field of the Invention

The invention generally relates to the field of sending and receiving network data. More specifically, the invention relates to network data security between two points on a network.

2. The Relevant Technology

Modern computer networks allow for the transfer of large amounts of data between clients within the network. Network clients, such as computers and other electronic devices, are often interconnected using a hub or router. A group of clients linked together in a central location is often referred to as a local area network (LAN). LANs can be interconnected through a wide area network (WAN). One example of a WAN is the ubiquitous Internet. Using a WAN, a user on one LAN can send data to a user on a separate LAN.

Many modern networks communicate by packaging data into data packets. The data packets generally include a header and a payload. The packet header generally includes routing information. The routing information may include information such as an originating client and a destination client. Each of the clients on the network may be assigned a unique number representing a physical address where packets may be sent. This number may be, for example, an IP address or a media access control (MAC) address. The payload generally includes the data that is intended to be transmitted between clients on the network.

Commonly, networking is accomplished using a model known as the Open Systems Interconnection (OSI) model or protocol stack. The OSI model defines a networking framework for accomplishing network communications. The OSI model includes seven layers on clients in the network. These seven layers are understood by those of skill in the art, and include from the highest level to the lowest level: the application layer, the presentation layer, the session layer, the transport layer, the network layer, the data link layer, and the physical layer. At the application layer, data is used in end user processes. Data is packaged by one or more of the other layers of the OSI model prior to being sent using the physical layer. Packaging includes organizing data into packets where the packets include parts such as a header and payload. The header includes information including routing information directing devices receiving the data packets where to send the data packets and for what devices the data packets are intended, information about protocols used to package the data packets, and similar information. The payload part of the data packet includes the information requested or for use by a device in a network. The physical layer defines the actual sending of the data on the network such as by electrical impulses, fiber-optic light beams, radio signals etc. Thus, at the physical layer, actual voltages, light levels and radio levels or frequencies are defined as having certain logical values.

The interconnectivity of LANs presents the challenge of preventing unauthorized users from gaining access to clients. Additionally, the large amounts of data that can be transmitted in modern networks often requires the ability to analyze large amounts of network traffic to troubleshoot network problems. There is also often the need to document and categorize network traffic, including information such as to where the network traffic is being directed and the most active times on network.

One way of monitoring network traffic to prevent unauthorized interception of the network traffic, to analyze the network traffic for troubleshooting, and to document network traffic, involves the use of a tap. The tap may be connected to a link that is associated with or a part of, the hub or router. Commonly available taps are passive devices that simply allow for monitoring network traffic. In one example, a copy, or all data on the network passes through the tap. The taps do not act as an interactive client on the network. The taps may be further connected to a data analyzer, or an intrusion detection system (IDS) that monitors for unauthorized clients on the network.

While taps are useful for providing access to and gathering network traffic, which enables it to be analyzed and monitored, they have the unfortunate drawback of, in many cases, representing a hole or leak in the network. An unauthorized user may connect a network analyzer or other network traffic collection device to the tap, allowing the aunauthorized user to capture and misappropriate the network traffic. This may result in the loss of sensitive information such as trade secrets, financial information or other protected data. Commonly, the only protection afforded to the tap may be by nature of the physical location where the tap resides, such as in a locked closet or other secure location. Thus, any unauthorized user who gains access to the physical location may be able to misappropriate the network traffic.

While these problems have been framed in the context of a tap connection on a router or hub, similar problems plague other network connections as well, thus the solutions and advantages achieved by embodiments of the present invention are not limited to communications between a tap and another device. Other devices commonly used on networks to interconnect devices on the networks are hubs and routers. As discussed previously, hubs and routers provide a means for interconnecting a group of clients on a network. The hubs and routers generally provide ports where clients can connect for sending and receiving network data. A hub operates by receiving data and repeating that data to other ports on the hub. A hub serves as an especially vulnerable point in a network where network data may be misappropriated. By connecting to one of the ports that repeats the data on the network, an intruder may misappropriate network data. Routers are somewhat more secure in that a router routes information on a network to a port where a device for which the data is intended is located. Nonetheless, an intruder may be able to connect to a router by spoofing (i.e. pretending to be) an address allowed by the router to be on the network. The intruder will then have access to data intended for the address which the intruder has spoofed. Thus, hubs and routers represent another leak where network data may be misappropriated.

### BRIEF SUMMARY OF THE INVENTION

One embodiment of the invention includes a method for establishing a secure point to point link. The method includes initiating a trusted link by authenticating a trusted partner. Authenticating a trusted partner may involve, for example, verifying a key sent from the trusted partner or exchanging keys with the trusted partner. The method also includes encrypting data to be sent on the trusted link. Encrypting may be done, for example, by using a hardware embedded encryption key or random or pseudorandom encryption key generated by a random or pseudorandom generator using a hardware embedded key. The method also includes sending the encrypted data on the trusted link. The method further includes policing the trusted link by verifying that the trusted partner remains connected to the trusted link and that other un-trusted clients are not connected to the trusted link. If the trusted partner becomes disconnected, or if an un-trusted client is connected to the trusted link, the method includes ceasing to send data on the trusted link.

Another embodiment of the invention includes a secure network interface device for use in a secure point to point link. The network interface device includes a first interface configured to receive encrypted network traffic. The network interface device also includes logic to decrypt the encrypted network traffic. The logic includes a hardware embedded encryption key matched to a network device that sends the encrypted network traffic. The a network interface device also includes a second interface adapted to connect to a host and to deliver the decrypted network traffic to the host device.

Yet another embodiment of the invention includes a secure network traffic distribution device for use in a secure point to point link. The secure network traffic distribution device includes an input configured to receive network traffic. The secure network traffic distribution device also includes an encryption module attached to the input. The encryption module includes a first hardware embedded encryption key used to encrypt network traffic. The first hardware embedded encryption key is matched to a device that is configured to receive encrypted network traffic from the secure network traffic distribution device. The secure network traffic distribution device also includes an output port coupled to the encryption module. The output port is configured to transmit encrypted network traffic.

Some embodiments of the invention allow for secure point to point communication by sending data only between known devices on the network. As a further security measure, encryption, in some cases of both payload data and header data, prevents reading of the network traffic. Thus unauthorized or un-trusted devices are not able to misappropriate network traffic.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a trusted connection between points on a network;

FIG. 2 illustrates a secure tap connected to a secure network interface card;

FIGS. 3A, 3B and 3C illustrate embodiments of secure network interface cards;

FIG. 4 illustrates a 1×1 GigE secure tap;

FIG. 5 illustrates a 1×1 GigE secure combo tap;

FIG. 6 illustrates a 1×N GigE secure replicating tap;

FIG. 7 illustrates a 1×N secure protocol distribution tap;

FIG. 8 illustrates a secure switch connected to a number of secure network-interface cards;

FIG. 9 illustrates a 1×N GigE secure tap;

FIGS. 10A and 10B illustrate authentication links for use in various embodiments;

FIG. 11 illustrates an exemplary modulator for sending out of band authentication and policing information on a high-speed data link;

FIG. 12 illustrates an alternate embodiment of a secure tap;

FIG. 13 illustrates an alternate embodiment of a secure tap;

FIG. 14 illustrates modifications to an Xgig blade to implement embodiments of the present invention; and

FIG. 15 illustrates a secure tap and secure host bus adapter that implement secure SFP modules.

### DETAILED DESCRIPTION OF EMBODIMENTS OF THE INVENTION

Embodiments of the present invention establish a secure or trusted point to point link by using a trusted point to point link between a pair of trusted devices. To maintain the trusted point to point link, methods disclosed herein operate by authenticating points in the link, encrypting data sent across the link, and policing the link to ensure that trusted partners are not removed or replaced with unauthorized devices. If an unauthorized device is added to or discovered in the link, embodiments of the invention will cease communication to prevent unauthorized interception of the network traffic. These secure point to point links can be used in combination with taps to substantially prevent unauthorized access to network data.

Secure network taps configured and used as disclosed herein provide the benefit of permitting convenient access to network data for purposes of monitoring or analyzing by authorized users, while substantially preventing unauthorized users from gaining such access. The secure point to point links can also be used with secure switches, routers and hubs for creating networks where secure links exist between network interface devices connected to the switches, routers or hubs. Secure host bus adapters provide one way of creating secure points in a point to point link. For example, secure host bus adapters may be added to a router, hub, client or other network device.

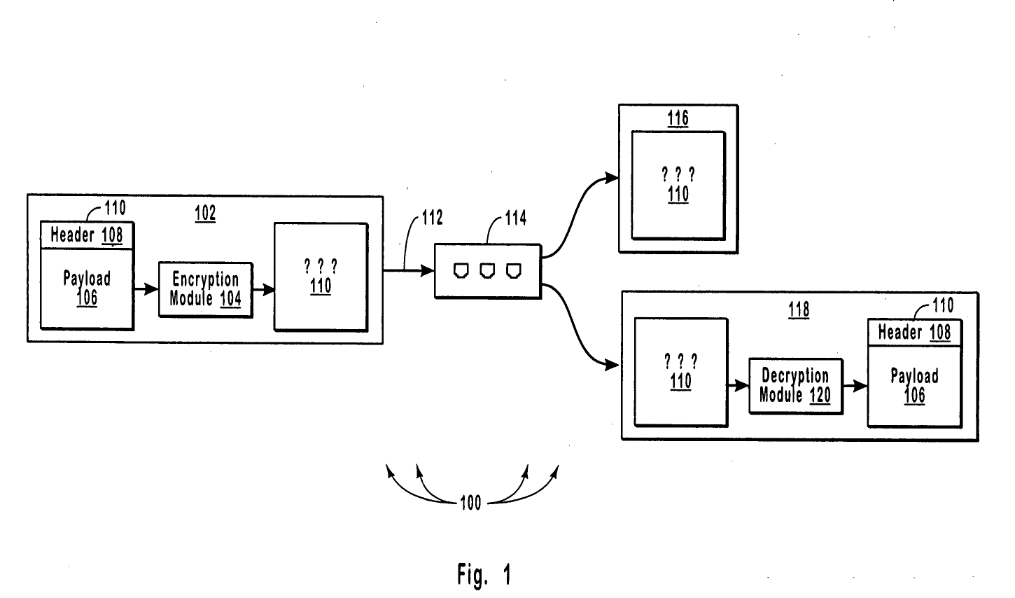

Referring now to FIG. 1, various aspects of one embodiment of the present invention are shown. FIG. 1 illustrates a point to point link generally designated at 100. A first secure connection point is at 102, which may be a secure network traffic distribution device such as a tap, switch, router, hub, client or other network connection device. In one embodiment, the first connection point 102, which in some embodiments may also be referred to as a trusted partner, authenticates a trusted partner 118 using an authentication process prior to sending data captured from the network traffic across the trusted link 112. An authentication process involves performing steps to verify the identity of the connection points.

The connection points and trusted partners may exchange passwords or keys only available to trusted partners or connection points. This exchange may be accomplished in a number of ways. Some embodiments of the invention use an out of band data link, where authentication data is sent separately from high-speed data. The term “high-speed data,” as used herein, does not refer to any particular defined bandwidth or frequency of data. Rather, high-speed data refers to data typically transmitted on a network such as the data typically transmitted for the benefit of the various hosts on a network. High-speed data may be, for example, captured network traffic. In one example, an authentication connection dedicated to authentication data may be used to exchange passwords or keys. In this example, authentication logic, which is used to transmit and receive authentication information, is connected to the authentication connection. Logic as used herein may be programming code and/or associated hardware. Further, the logic may include analog circuitry and processing and is not necessarily limited to digital functions.

According to other embodiments, the authentication information may be sent on the trusted link 112, thus obviating the need for a separate authentication link. Sending authentication information on the trusted link 112 may be accomplished in a number of different ways. For example, when a trusted partner 118 is first connected to the trusted link 112, high-speed data flows from the trusted partner 118 to the first connection point 102, thus allowing the first connection point to authenticate the trusted partner 118. If the trusted partner 118 is an acceptable device to send network traffic to, the high-speed data flow reverses and flows from the first connection point 102 to the trusted partner 118 thus allowing for transfer of network traffic.

Encryption keys that are embedded in the hardware of the first connection point 102 and the trusted partner 118 are used to encrypt network traffic that can be sent on the trusted link 112. Encrypting may include scrambling the network traffic by using an algorithm that utilizes the hardware embedded encryption key. By embedding the encryption keys in the hardware, as opposed to implementing the encryption keys in software, the encryption algorithm can be made more secure and efficient. In another example, a random or pseudorandom encryption key is generated using a generation algorithm that makes use of. a hardware embedded encryption key. Devices that do not specifically have certain information embedded in the hardware of the device are not able to generate the correct random or pseudorandom encryption key. The random or pseudorandom encryption key is created each time a trusted partner 118 is connected to the trusted link 112. In addition to being used to encrypt network traffic, the random or pseudorandom encryption key may also be used in the authentication process. If a partner cannot create the correct random or pseudorandom encryption key, the first connection point 102 recognizes that the partner is not, a trusted partner. As such, if a trusted partner 118 is disconnected and replaced with an unauthorized device 116, the unauthorized device 116 nonetheless can be recognized as an unauthorized device when the first connection point 102 attempts to authenticate the unauthorized device 116.

The first connection point 102 includes an encryption module 104. The module 104 may be embodied, for example, as programming code and/or associated computer hardware. The encryption module 104 encrypts both the payload 106 and the header 108 of data packet 110 such that the data packet 110 is unreadable by ordinary network devices. This encryption is done using an encryption algorithm that uses for example, a hardware embedded encryption key or randomly generated encryption key. Exemplary encryption algorithms include encryption algorithms using keys, public/private keys and the like.

The data packet 110 shown in FIG. 1 may be a data packet traveling on a network that is to be analyzed by a network analyzer or IDS. The encrypted data packet 110 may be sent on a trusted link 112. A hub 114 provides multiple connection points for devices to connect. Each connection point in the hub 114 has the same data appearing at each connection point at any given time. In the example shown in FIG. 1, an unauthorized device 116 is connected to the hub 114. When the unauthorized device 116 receives the encrypted data packet 110, the unauthorized device 116 cannot read the encrypted data packet 110. Additionally, because the header 108 is encrypted, the unauthorized device does not know the destination of the encrypted data packet 110 and will thus likely ignore the encrypted data packet 110. FIG. 1 also illustrates a trusted partner 118. The trusted partner 118 receives the encrypted data packet 110 and passes the encrypted data packet through a decryption module 120. The decryption module 120 decrypts the encrypted data packet 110 such that the header 108 and payload 106 are once again readable.

In one embodiment, the first connection point 102 polices the trusted link 112 using policing logic by constantly or periodically monitoring the trusted link 112 for suspicious activity. When the first connection point 102 discovers the existence of the unauthorized device 116, the first connection point 102 may cease communications across the trusted link 112. This prevents the unauthorized interception of network traffic. Once the unauthorized device 116 has been removed from the trusted link 100, the first connection point 102 can reauthenticate the trusted partner 118 and reestablish communications across the trusted link 112.

In one embodiment, an unauthorized device 116 that attempts to misappropriate the network traffic may be discovered by using digital diagnostics. For example, a device, such as the first connection point 102, may monitor the trusted link 112 to determine that a trusted partner 118 has been unplugged from the trusted link 112 or that another device is attempting to be plugged into the trusted link 112. In the case where the trusted link 112 is an optical link, loss of optical signal power may indicate that an unauthorized device 116 has been added to the trusted link 112 or that the physical layout has been changed, such that an optical fiber has been bent away from a trusted partner 118. Alternately, the first connection point 102 may periodically authenticate the trusted partner 118. As used herein, the term “periodically” refers to the act being performed more than once or in successive instances and does not necessarily imply regular or uniform intervals. Illustratively, a trusted partner 118 periodically exchanges or sends authentication information on an out of band or authentication connection.

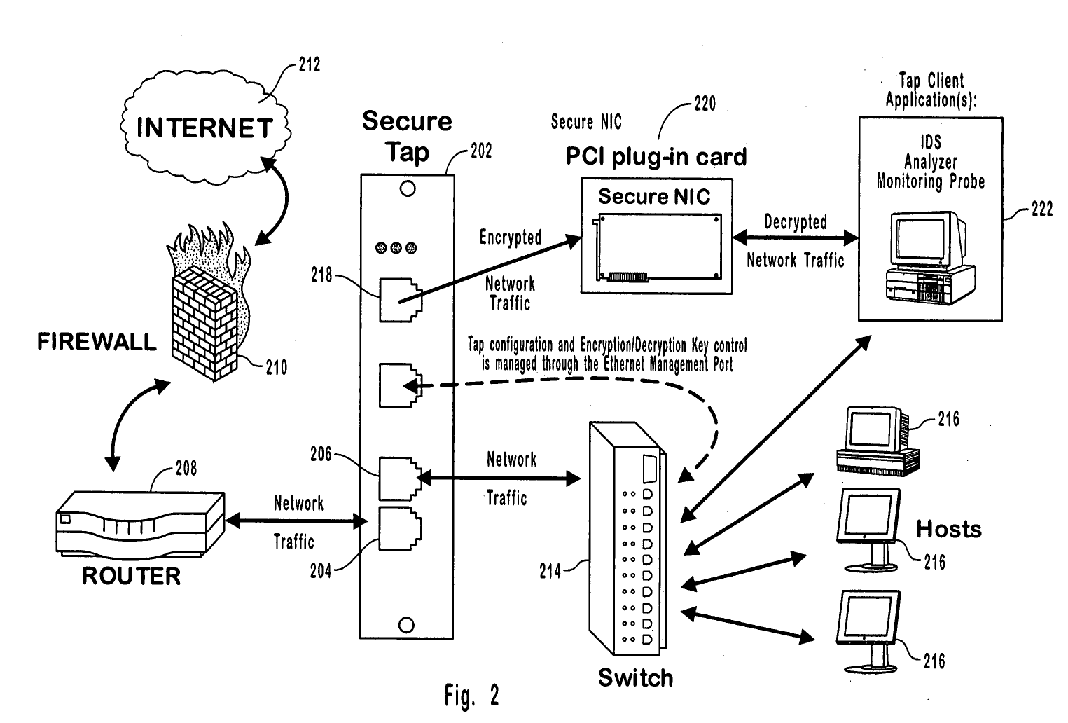

FIG. 2 illustrates a network diagram with a secure network traffic distribution device embodied as a secure tap according to an alternate embodiment. The secure tap 202 includes a hardware embedded encryption key for communicating encrypted data to a trusted partner. The secure tap 202 includes network ports 204 and 206. The network ports 204 and are configured to pass through network traffic from each other. In the example of FIG. 2, the network port 204 is connected to a router 208, which is connected to a firewall 210 through which the network may be connected to the Internet 212. The firewall 210 may be implemented, for example, as a hardware device in the router 208. A LAN may be connected to the secure tap 202 through the network port 206. A switch 214 provides connection points to connect various hosts 216 in a LAN configuration. Connecting the router 208 and switch 214 through the secure tap 202, at the network ports 204 and 206, allows the hosts 216 to connect to the Internet 212 for sending and receiving data. The secure tap 202 includes a secure tap port 218. The secure tap port 218 provides a connection point for distribution of network traffic replicated from the network ports 204 and 206. The secure tap port 218 is connected to hardware within the secure tap 202 for encrypting any data sent on the secure tap port 218. The encryption is performed using encryption keys stored on the hardware of the secure tap 202. Alternatively, the encryption may be performed using a random or pseudorandom encryption key generated by or communicated to the secure tap 202, where the encryption key is generated using a hardware embedded key. Those of skill in the art will recognize that other encryption methods may also be used.

In the embodiment shown in FIG. 2, a secure network interface card (NIC) 220 is connected to the secure tap port 218 using, for example, a standard RJ-45 cable. Wireless or other connections may also be used. The secure NIC 220 may be a PCI plug-in card or other host bus adapter that is capable of connecting to a PCI bus in a computer device, such as a network analyzer or IDS. The secure NIC 220 is not limited to host bus adapters, but may also be other types of devices including but not limited to devices integrated into the mother board or other circuitry of a host, devices connected by serial connections, USB connections, IEEE 1394 connections and the like. Other embodiments of the invention include using devices that perform the function of the secure NIC 220, whether or not those devices can be classified as NICs. The secure NIC 220 includes an encryption key matched to the encryption key in the secure tap 202 for communicating and decrypting network traffic sent from the secure tap port 218. As previously mentioned, the secure NIC 220 may be installed in any appropriate network analyzing device.

As shown in FIG. 2, the NIC 220 in this example is installed in either an IDS, an analyzer, or a monitoring probe 222, although other network analyzing tools may be used. The secure NIC 220 represents at least a portion of the trusted partner 118 shown in FIG. 1. By packaging portions of a trusted partner in a secure NIC, such as the secure NIC 220, the secure tap 202 can be matched in a trusted pair with any device capable of operating the secure NIC 220.

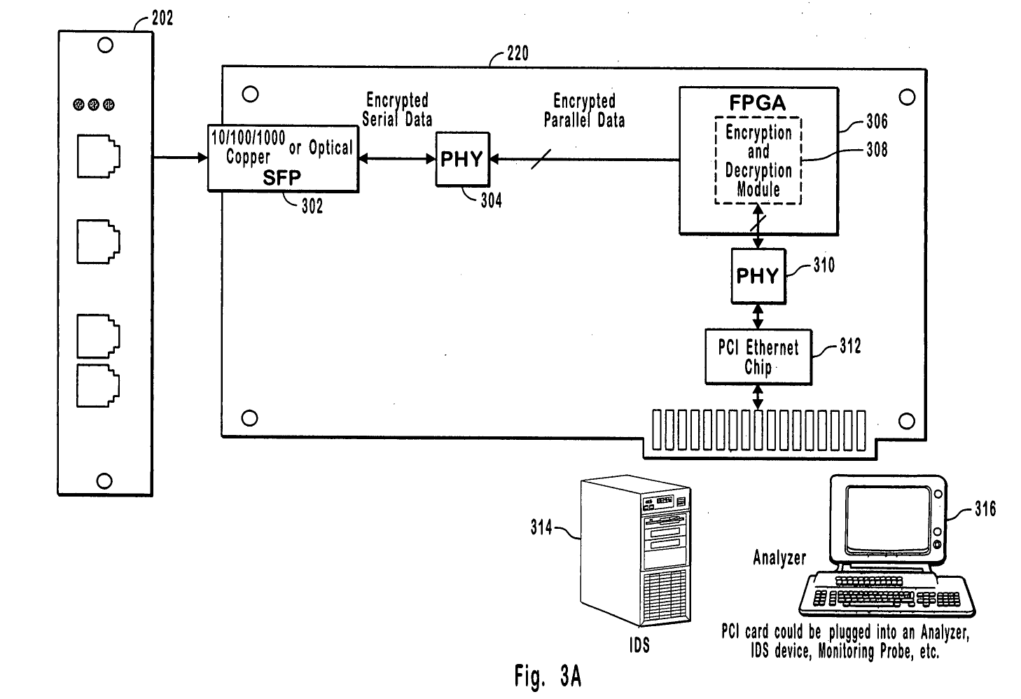

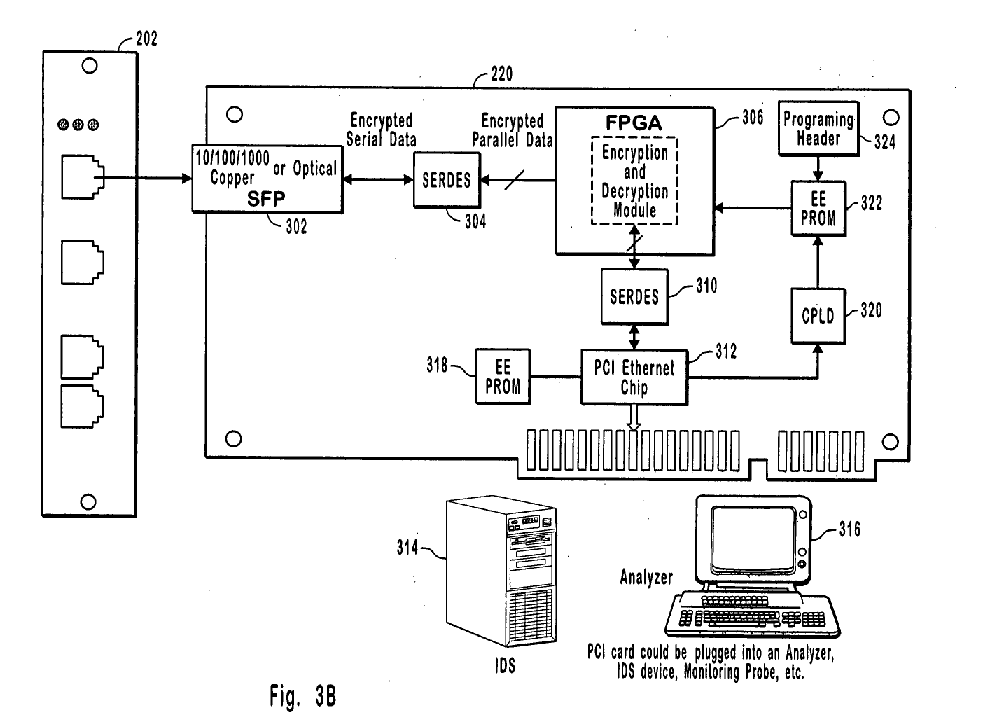

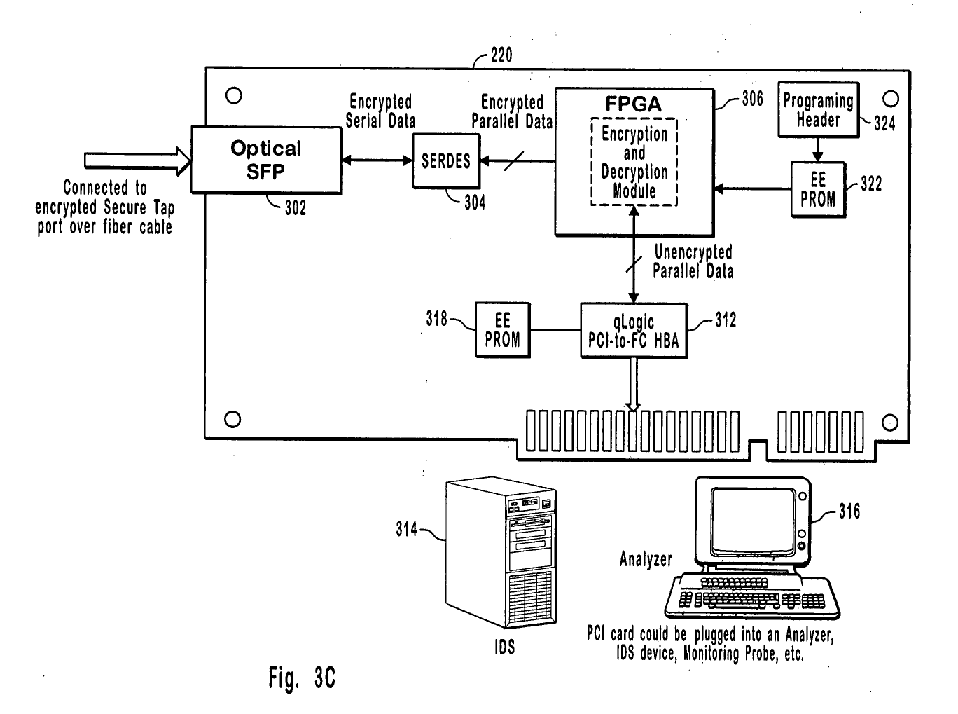

FIG. 3A illustrates a secure NIC 220 that complies, in this example, with the Gigabit Ethernet (GigE) standard. Such a NIC may be usable in optical or high-speed wired networks. As such, the secure NIC 220 includes a network connector such as in this case a small form factor pluggable (SFP) module 302, although the module 302 may also be XFP or any other appropriate module. The SFP module 302 receives encrypted network traffic from the secure tap 202. Other embodiments may use other connection modules, transceivers and the like. In the embodiment shown in FIG. 3A, encrypted network traffic is received by the SFP module 302 in a serial data stream. The encrypted serial data stream is sent to a physical layer device 304. Physical layer device 304, in this example, is a SERializer/DESerializer (SERDES) that converts the encrypted serial data to encrypted parallel network traffic. The encrypted parallel network traffic is then fed into a field programmable gate array (FPGA) 306 that includes an encryption and decryption module 308. The encrypted parallel network traffic is converted to unencrypted parallel network traffic by the encryption and decryption module 308. This unencrypted parallel network traffic is fed to a physical layer device 310, a SERDES, that converts the unencrypted parallel network traffic to unencrypted serial network traffic. The physical layer device 310 may be for example, part number VSC7145 available from Vitesse Semiconductor Corporation of Camarillo, Calif. The unencrypted serial network traffic is received by a PCI Ethernet chip 312 that acts as a portion of an interface to a host device in which the NIC 220 is installed. Such a host device may be an IDS 314, an analyzer 316, a monitoring probe, etc. Alternate embodiments of the NIC 220 may be used. For example, the NIC 220 may be embodied as a host bus adapter including a PCI bus connection. In other embodiments of the invention, the NIC 220 is a network interface device with an USB connector or IEEE 1394 (Firewire®) connector. Other interfaces are also within the scope of embodiments of the present invention.

FIG. 3B illustrates another embodiment of a secure NIC 220 that includes logic, for updating program and other codes for the FPGA 306. The NIC 220 includes a PCI Ethernet chip 312, which in this example is part number 82545EM available from Intel Corporation of Santa Clara, Calif. The NIC 220 includes a microprocessor or other logical operating device such as a complex programmable logic device (CPLD) 320 coupled to the PCI Ethernet chip 312. The PCI Ethernet chip 312 has software definable signals that can be used to send code for the FPGA 306 to the CPLD 320. The CPLD 320 is coupled to memory such as an EEPROM 322 that stores code for use by the FPGA 306. The EEPROM 322 is coupled to the FPGA 306 for delivering code to the FPGA 306. By sending code through the PCI Ethernet chip 312 and the CPLD 320 to the EEPROM 322, the EEPROM 322 can be “flashed” with updated code such as new encryption keys or operating instructions. A programming header 324 is also included in the embodiment of FIG. 3B. The programming header may be a mechanical and/or electrical interface usable to transfer code to the EEPROM 322 when the NIC 220 is manufactured, or at some other time when the NIC 220 is not installed in a host device.

FIG. 3C shows a secure NIC 220 for use in Fibre Channel networks. In this embodiment, a PCI to fibre channel (FC) host bus adapter (HBA) 312 connects the FPGA 306, and the unencrypted network traffic, to an IDS 314 or analyzer 316 through a PCI interface. The PCI to FC HBA 312 may be obtained, for example, from qLogic of Aliso Viejo, Calif.

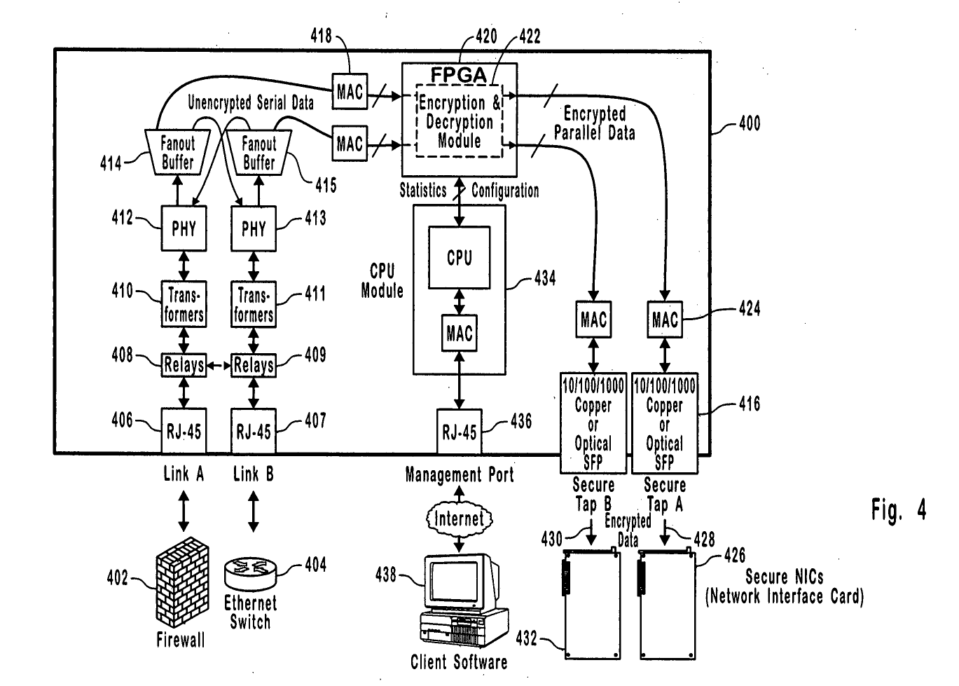

FIG. 4 shows a 1×1 GigE copper/optical tap 400 that allows for monitoring two streams of network traffic. In the example shown in FIG. 4, network traffic streams from the Internet through a firewall 402 and network traffic streams from a local area network routed through an Ethernet switch 404 are monitored. Network connections in the example shown in FIG. 4 may be made using RJ-45 connectors 406 and 407. Other embodiments of the invention may use other connectors including wireless links.

During operation of tap 400, the network traffic passes through the firewall 402 into a RJ-45 connector 406. The network traffic passes through a relay 408 that is configured such that, if there is no system power to the optical tap 400, the network traffic is routed through the relay 409, the RJ-45 connector 407 and to the Ethernet switch 404. In this way, the data link is never broken even when the tap 400 is without power. When the tap 400 is powered, the network traffic passes through the relay 408 to a transformer 410. The transformer 410 provides, in this example, the isolation and common mode filtering required to support category five UTP cables for use in Ethernet 100/1000 base T duplex applications. The transformer 410 facilitates simultaneous bi-directional transmission on a twisted pair by performing echo cancellation. The network traffic is passed from the transformer 410 to a physical layer device 412. The physical layer device 412 is part of layer 1 of 7 in the OSI model. The physical layer device 412 defines the protocols that govern transmission media and signals. A suitable PHY chip for use as part of the physical layer device 412 is made by Broadcom Corporation, of Irvine, Calif. The chip, part number BCM5464S, has four fully integrated 10BASE-T/100BASE-TX/1000BASE-T Gigabit Ethernet transceivers. The network traffic is passed from the physical layer device 412 to a fanout buffer 414. The fanout buffer, in one embodiment, is a logical chip that takes one differential signal as an input and creates a number of duplicate outputs. In this way, multiple copies of a tapped signal may be output. In one embodiment, up to five duplicate outputs may be implemented on a single fanout buffer. From fanout buffer 414, the network traffic is routed into two different directions.

In the example shown in FIG. 4, one output of the fanout buffer 414 is directed through a MAC layer device 418 into a FPGA 420. The MAC layer device 418 is a SERDES that converts unencrypted serial network traffic to unencrypted parallel network traffic. The FPGA 420 includes an encryption module 422 that encrypts the network traffic. Encrypted parallel network traffic is then sent to a second MAC layer device 424, which is a SERDES that converts the encrypted parallel network traffic to encrypted serial network traffic. The encrypted serial network traffic is fed into an SFP 416 where it is transmitted across a secure link 428 to a secure NIC 426. The secure NIC 426 is matched with the secure tap 400. The secure NIC 426 may be, for example, a secure NIC, such as that shown in FIG. 3A and H designated generally at 220. In this way, a secure link 428 exists between the secure tap 400 and a secure NIC 426.

A second output of the fanout buffer 414 is fed into the second physical device 413 which is then fed into a transformer 411, relays 409 and to a RJ-45 connector 407. Data going from the Firewall to the Ethernet switch uses this data path while data from the Ethernet switch to the Firewall uses the data path from fanout buffer 415 to PHY 412 to transformer 410 to relays 408 to RJ-45 connector 406.

In the example shown in FIG. 4, the secure tap 400 includes a link labeled B that provides a path for tapping the LAN network traffic that passes through an Ethernet switch 404. In a fashion similar to that described for the Internet traffic passing through the firewall 402, LAN network traffic can be passed from an Ethernet switch 404 to an RJ-45 connector 407, to a relay 409, to a transformer 411, to a physical layer device 413, to a fanout buffer 415, to the FPGA 420, and so forth until it is finally sent across a secure link 430 to a secure NIC 432 for monitoring the LAN network traffic. The secure NICs 426 and 432 may be installed in any appropriate device such as for example those described earlier including an IDS or a network analyzer.

The secure tap 400 also includes means for performing the function of managing the encryption and decryption module 422 on the FPGA 420. Corresponding structure is shown where the FPGA 420 is connected to a CPU module 434 that is further connected to a management port 436 that comprises a network connector. A management computer 438 may be connected to the management port 436 for controlling the FPGA 420. In one embodiment, Gn the hardware embedded encryption keys described previously may be in firmware, such as a flash ROM. Through the management port, the hardware embedded encryption keys may be changed or updated. Additionally, other types of tap management may be performed through the management port 436.

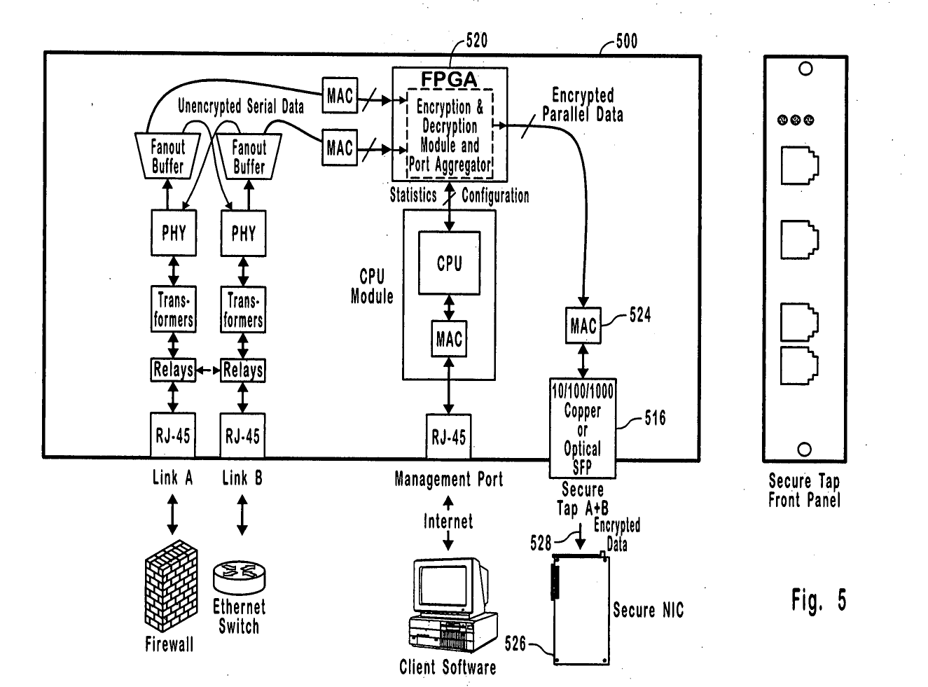

FIG. 5 illustrates a 1×1 GigE secure combo tap 500 that is similar to the embodiment of FIG. 4. The data path for Internet traffic and the LAN network traffic is similar to that shown in FIG. 4. The secure combo tap 500 differs from the secure tap 400 of FIG. 4 in that the Internet traffic and LAN network traffic are combined at the FPGA 520, such that a single encrypted parallel data stream that includes both the Internet traffic and the LAN network traffic is passed to a MAC layer device 524. The MAC layer device 524 converts the encrypted parallel network traffic to encrypted serial network traffic, which is then passed to an SFP module 516. The encrypted parallel network traffic is then transmitted across a secure link 528 to a secure NIC 526. In this way, both Internet traffic and LAN network traffic can be analyzed by a single network analyzer or IDS in which the secure NIC 526 is installed.

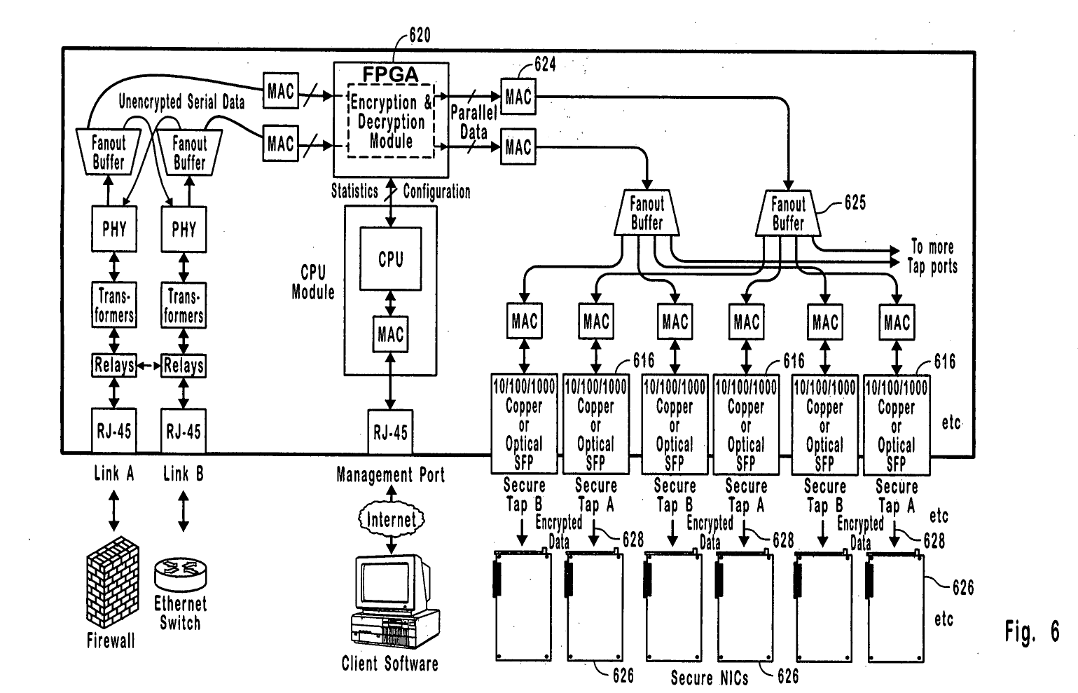

The embodiment shown in FIG. 6 is similar to the embodiment shown in FIG. 4. However the embodiment shown in FIG. 6 includes additional fanout buffers for data output from the FPGA 620. For example, a fanout buffer 625 receives encrypted serial network traffic from a MAC level device 624. As described above, the fanout buffer provides multiple copies of the encrypted serial network traffic input into the fanout buffer. In this way, several SFP modules 616 can be used to transmit encrypted network traffic at the physical level across a secure path 628 to secure NICs 626. The NICs 626 all receive the same secure network data which can be useful in terms of conducting a thorough analysis of the data. For instance, one NIC may be part of an IDS searching for a specific type of network intrusion while another NIC is part of another IDS searching for a different type of network intrusion. A third NIC may even be part of an analyzer capturing network traffic. This way, what one IDS may be unable to do because it is not fast enough to analyze all of the data, two or more IDSs may distribute the work and offer a more robust and total detection solution. Another reason to have multiple taps of the same traffic is for a configuration including several independent analyzers.

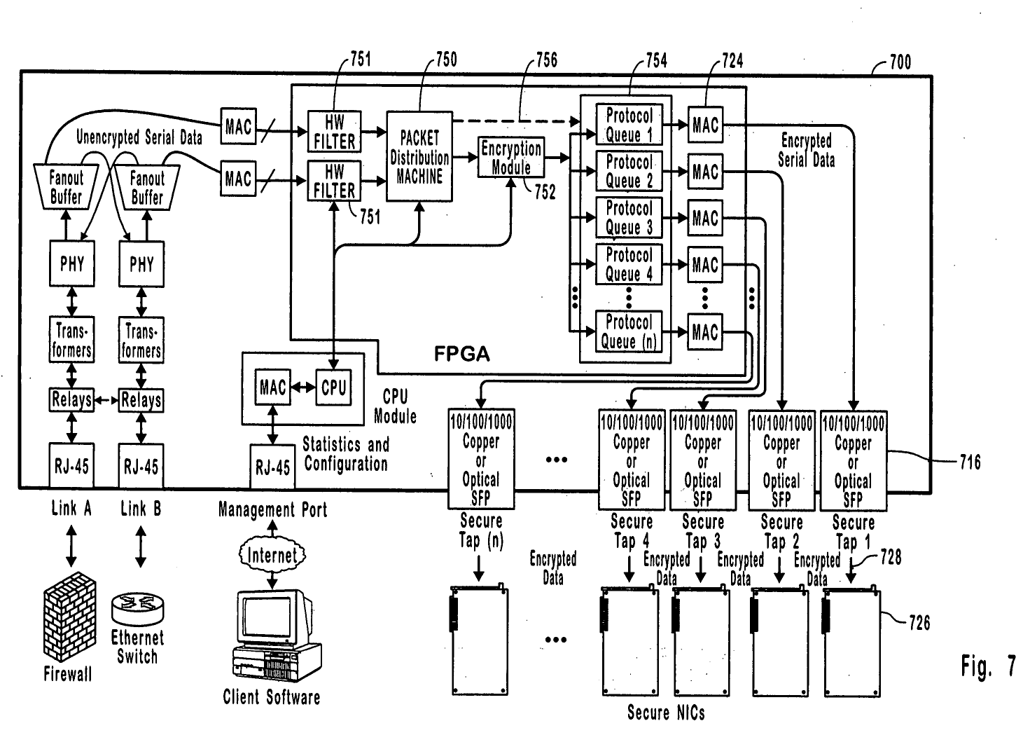

FIG. 7 shows a secure protocol distribution tap 700 that includes a hardware filter and a packet distribution machine. The hardware filter 751 can process Ethernet packets (discard, truncate, etc) according to various user-specified conditions. For example, if a user is not interested in ftp traffic on the link, the user could effectively setup the hardware filter 751 to discard any ftp packets. When the network traffic arrives at the secure NIC 726 in the user's IDS (such as IDS 314 in FIG. 3) or analyzer (such as analyzer 316 in FIG. 3) there will be no ftp packets. Because the IDS does not have to analyze and discard these ftp packets, this could save the IDS valuable processing time for more important operations. Another possible use of the hardware filter 751 is to truncate packets to discard unwanted data and/or payload. For example, if the user only wants to keep track of where the packets are coming from and where they are going, the hardware filter 751 could remove the payload. The hardware filter 751 can also recalculate frame data information such as the cyclic redundancy check (CRC) and other variables for just the header information. The hardware filter 751 would cause only the truncated packet to be sent to the secure NIC 726. After the data passes through the hardware filter 751, it enters the packet distribution machine 750, which can disperse packets according to protocol, packet size, error packets etc. For example, the packet distribution machine 750 divides packets of the Internet traffic and the LAN network traffic, in one embodiment of the invention, according to http, voice-over IP, TCP, IP, HTML, FTP, UDP, video, audio, etc. The packet distribution machine 750 passes the actual network traffic packets through an encryption module 752 to a protocol queue 754. The packet distribution machine 750 is also connected to the protocol queue 754 by a packet queue selection line 756 that directs the distribution of network traffic packets from the encryption module 752. Encrypted parallel network traffic from the protocol queues 754 is sent to a MAC level device 724 that converts the encrypted parallel network traffic to encrypted serial network traffic. The encrypted serial network traffic is then directed to SFP module 716. The SFP module 716 transmits the network traffic across a physical secure link 728 to the appropriate secure NICs 726. As with other examples illustrated herein, the secure NICs 726 may be installed in an IDS or a network analyzer. Specialized network analyzers or IDSs can be used to analyze particular types of network traffic. This allows for a network analyzer or IDS to be optimized for the particular protocol or packet types that it receives.

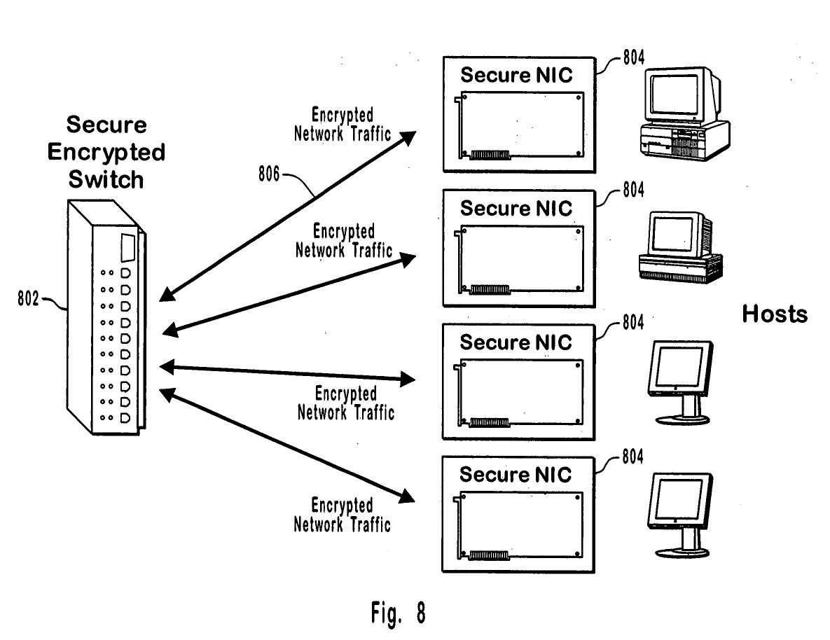

Embodiments of the present invention are not limited to secure links between a network tap and a secure NIC, secure network analyzer or similar device. Other embodiments of the invention extend to secure network traffic distribution devices embodied for example in FIG. 8 as a secure encrypted switch 802 and secure NICs 804 that are matched to the secure encrypted switch 802 for creating secure links 806. In a manner similar to that described above in reference to the secure tap and secure NIC, the secure encrypted switch 802 and secure NICs 804 authenticate one another, encrypt and transmit encrypted network traffic across the secure link 806 and police the secure link 806 for indications that a secure NIC 804 has been removed from the secure link 806 or that other types of intrusion are taking place. Those of skill in the art recognize the secure network traffic distribution device may also be embodied as a secure hub or secure router and the like.

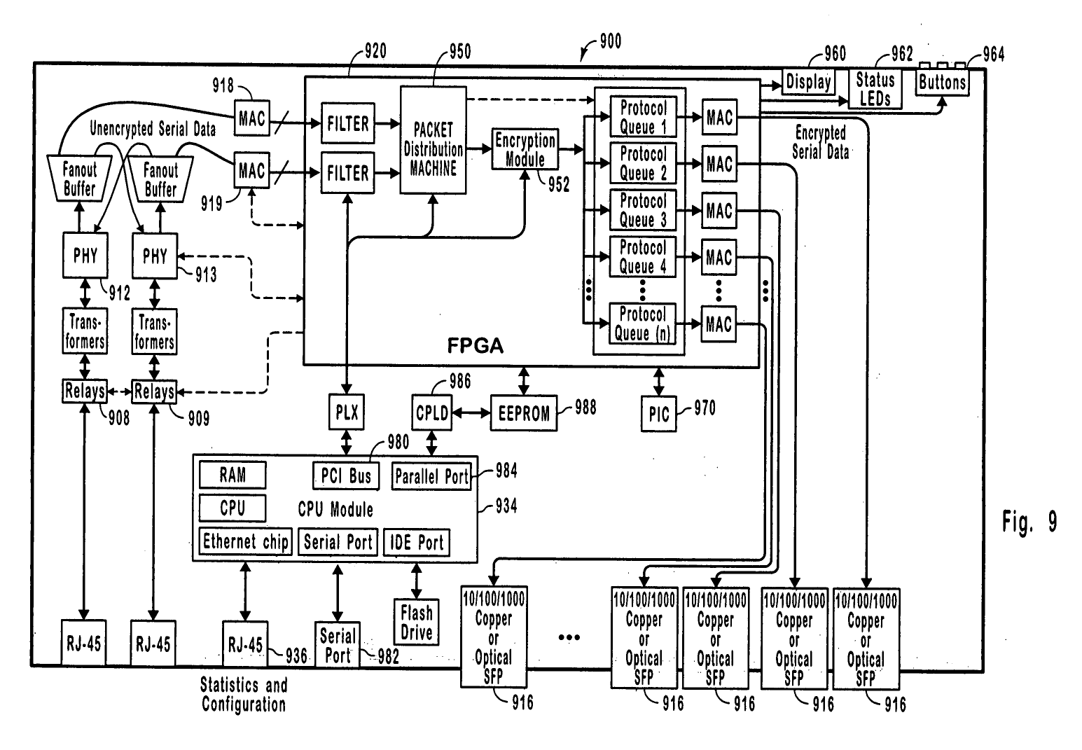

Referring now to FIG. 9, various other features that may be implemented in embodiments of the present invention are illustrated. FIG. 9 shows a 1×N GigE secure tap 900 that includes an FPGA 920. The FPGA 920 is adapted to control various devices in the secure tap 900. For example, the FPGA 920 controls all of the physical layer devices 912 and 913, MAC layer devices 918 and 919, relays 908 and 909, and SFP modules 916. The FPGA may also be configured to control a display 960. The display 960 can be, for example, an LCD display that shows port configuration, link status, statistics etc. The link may also display IP addresses and other configuration details. The FPGA 920 may also control a number of status LEDs 962. The status LEDs 962 indicate power, board booting status, operating system status etc. The FPGA 920 may also receive input from a number of buttons 964. The buttons may be used to control port configurations, IP addresses and so forth.

The FPGA 920 can be connected to a programmable integrated circuit (PIC) 970. The PIC 970 measures temperature, supply voltages and holds specific product data. Such product data may include product operating parameters, model numbers, output and input specifications and so forth.

In one embodiment of the invention, the FPGA 920 has various connections to a CPU module 934. One such connection may be through a PCI bus 980. The CPU module 934 may communicate various commands to the FPGA 920 through the PCI bus 980, such as how the secure tap 900 should be configured, how to route packets in a package distribution machine 950, communication of encryption keys to encryption module 952, control information for the physical layer devices 912 and 913, the relays 908 and 909, etc. In addition, or as an alternative, to receiving configuration information from an RJ-45 configuration port 936 a serial port 982 or other device may be used to configure IP addresses and control the secure tap 900.

The CPU module may also include a parallel port 984 for communicating with and/or reprogramming the FPGA 920. The parallel port 984 transmits code to a complex programmable logic device (CPLD) 986, which is a programmable circuit similar to an FPGA but smaller in scale. The CPLD 986 may transmit the code to an EEPROM 988 where the code would be loaded into the FPGA 920 at the appropriate time.

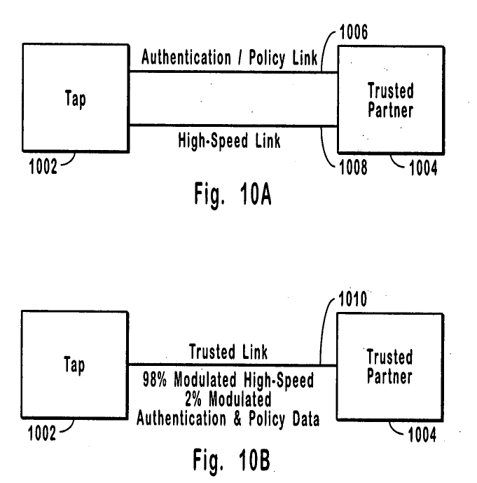

FIGS. 10A and 10B, illustrate a tap 1002 that implements methods of authenticating a trusted partner and policing a trusted link. Tap 1002 is connected to trusted partner 1004 by both an authentication/policing link 1006 and a high-speed link 1008. The authentication/policing link 1006 and the high-speed link 1008 together represent a trusted link. The tap 1002 and a trusted partner 1004 communicate authentication information as out-of-band data across the authentication/policing link of 1006. Such information may include encryption keys, identity information and the like. The high-speed link 1008 carries the high-speed data which may be for example, the network traffic captured by the tap 1002. In one embodiment, the high-speed link 1008 carries encrypted network traffic from the tap 1002 to the trusted partner 1004.

The term “high-speed data,” as used herein, does not refer to any particular defined bandwidth or frequency of data. Rather, high-speed data refers to data typically transmitted ran on a network such as the data typically transmitted for the benefit of the various hosts on a network. High-speed data may also be referred herein as in-band data which is a reference to the communication band typically used by host systems to communicate data. High-speed and in-band data are distinguished from out-of-band data which is typically used to transmit data from transceiver to transceiver for the use of the transceivers. While a host may subsequently receive the out-of-band data, the host usually receives the out-of-band data from a transceiver through an IC bus such as an I²C or MDIO bus. This is contrasted to high-speed data which is typically received by a host from a transceiver through some type of high-speed data interface. Notably, a host may also produce the out-of-band data and transmit the out-of-band data to a transceiver on an IC bus.

As illustrated in FIG. 10B, authentication and policing data can be sent across the trusted link with the high-speed data as modulated out-of-band data. In FIG. 10B, tap 1002 is connected to a trusted partner 1004 by a trusted link 1010, which may be an optical fiber link. The signal transmitted on the trusted link 1010 is modulated by two sources. A first source is a modulator that modulates the high-speed data. A second source modulates and out-of-band data signal on the trusted link to communicate authentication and policing data. In the example shown in FIG. 10B, where the signal is a light signal, approximately 98% of the light signal modulation represents modulated high-speed data. On the other hand, approximately 2% of the modulated light signal represents authentication and out-of-band policing data. Those of skill in the art can appreciate that other high-speed data to out-of-band authentication and policing data ratios may be used without departing from the scope of embodiments of the invention. The out-of-band modulated authentication and policing data may be at a data rate that is significantly slower than the data rate of the modulated high-speed data.

Several different modulation schemes exist for modulating the authentication and policing data. For example, an amplitude modulated signal may communicate binary data bits from the tap 1002 to the trusted partner 1004. Other types of modulations may also be used including, but not limited to, binary phase shift keying, quadrature phase shift keying, non return to zero (NRZ) encoding, Manchester encoding and other types of keying.

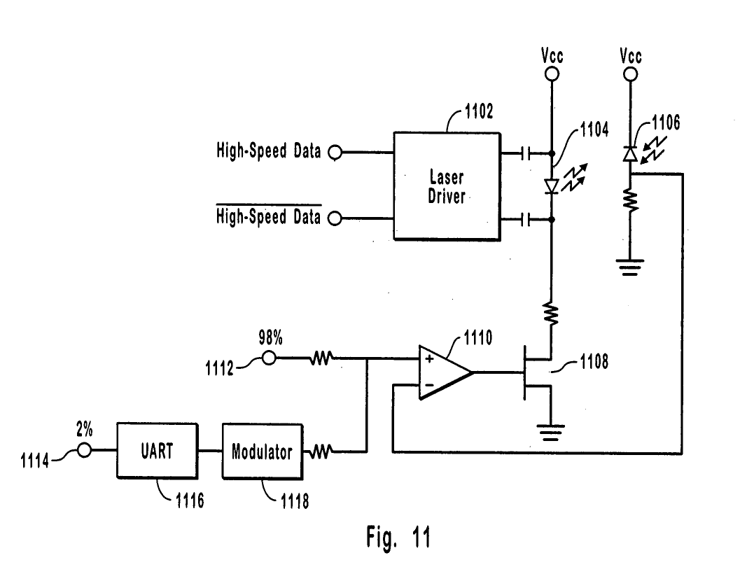

FIG. 11 illustrates a method of modulating the signal on the trusted link using a laser driver 1102 that controls a laser diode 1104. The laser driver 1102 receives high-speed data. In this example, the high-speed data is a differential signal as indicated by the labels High-Speed Data and \overline{High-Speed_Data}. Also shown in FIG. 11 is a monitor photodiode 1106 for monitoring the output power and other characteristics of the laser diode 1104. A transistor 1108 controls the power of the laser diode 1104. The transistor 1108 is controlled by a differential amplifier 1110 that receives a high-speed data bias input 1112. The differential amplifier also receives an authentication and policing signal 1114. Authentication and policing signal 1114 is fed into a universal asynchronous receiver-transmitter (UART) 1116, which is a device used to control serial communications. Serial data from the UART 1116 is fed into a modulator 1118. The modulator 1118 produces a modulated signal that is combined with the high-speed data bias input 1112, where the combination of signals is fed into the differential amplifier 1110 at the non-inverting input. This input at the non-inverting input of the differential amplifier 1110 serves as one parameter to modulate the output power of the laser diode 1104. Thus, by modulating authentication and policing data, the power of the laser diode 1104 may be modulated, thereby embedding authentication and policing data with the high-speed data. The monitor photodiode 1106 also controls the output power of the laser diode 1104 by virtue of its connection through the inverting input of the differential amplifier 1110.

The modulation scheme shown in FIG. 11 is just one example of modulation schemes that may be used to modulate high-speed data with authentication and policing data. For example and not by way of limitation, embodiments may modulate average power of a laser diode with authentication and policing data. Embodiments may modulate peak power of a laser diode with authentication and policing data. Still other embodiments may modulate a combination of peak power and average power with authentication and policing data. Various modulation devices and method are described in U.S. patent application Ser. No. 10/824,258 titled “Out-of-Band Data Communication Between Network Transceivers” filed Mar. 14, 2004 which is incorporated herein by reference.

Referring again to FIG. 10B, when the trusted partner 1010 needs to send authentication and policing data to the tap 1002, the data may be sent in a variety of different ways. For example, because of the directional nature of light travel, authentication and policing data may simply be sent using any convenient form of modulation to the tap 1002.

The authentication and policing data may be extracted by using a standard infrared television remote control decoder. For example, IR receivers T2525, T2527 and U2538B available from Atmel Corporation in San Jose, Calif. may be used to decode the authentication and policing data.

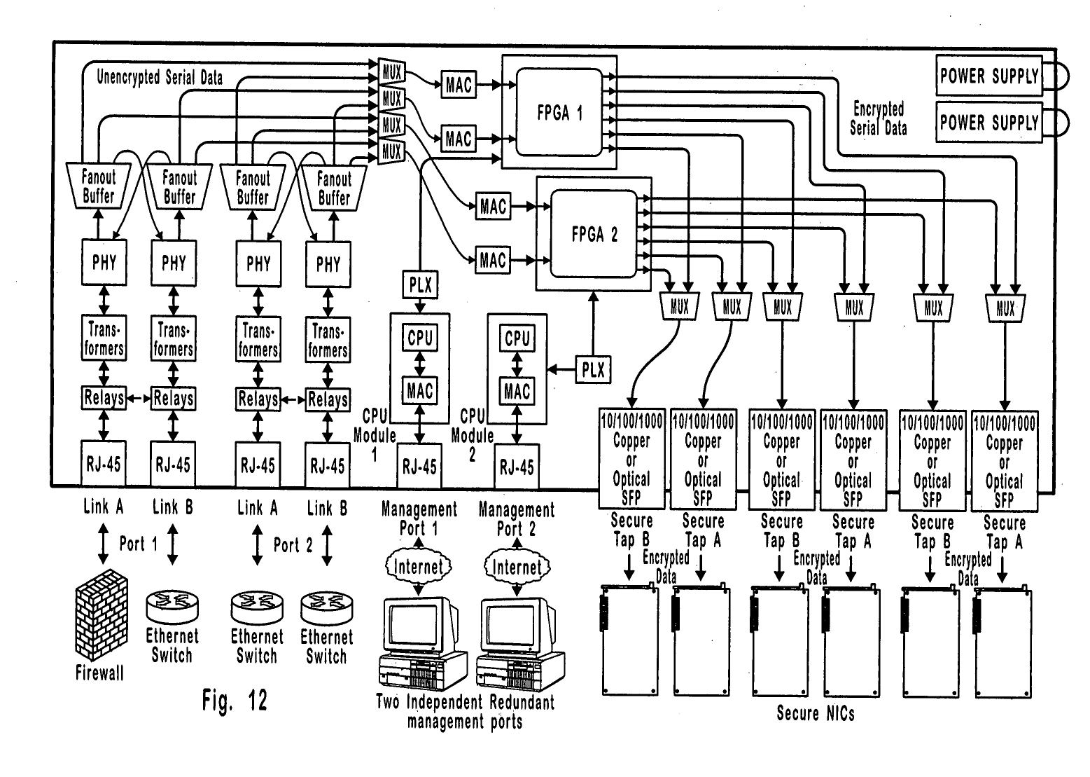

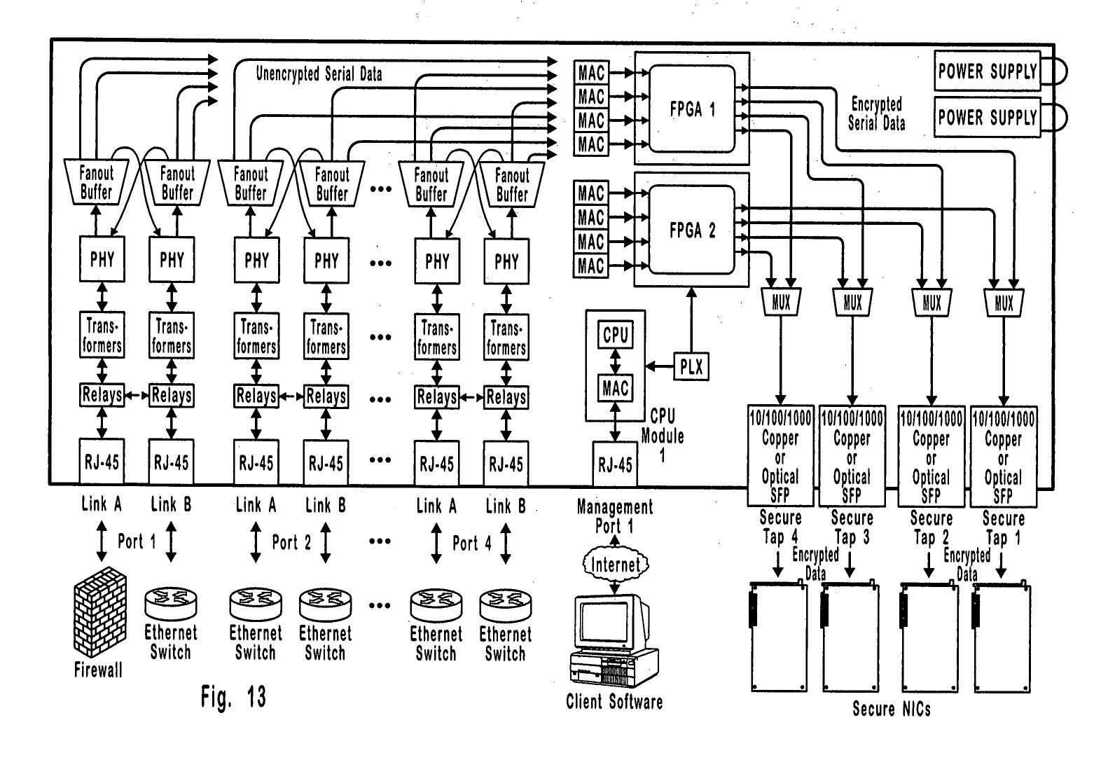

Various other embodiments of the invention exist. For example, FIGS. 12 and 13 illustrate other embodiments, that although not specifically described, may be understood by reference to the principles embodied by other embodiments of the invention set forth herein. Notably, FIGS. 12 and 13 illustrate the scalability of embodiments of the present invention. For example, FIG. 12 illustrates an additional port 2 for input of Ethernet data. FIG. 12 also includes two independent management ports, management port 1 and management port 2, for tasks such as managing the various algorithms and encryption keys used by the embodiment shown. FIG. 13 illustrates the scalability of ports in embodiments of the present invention.

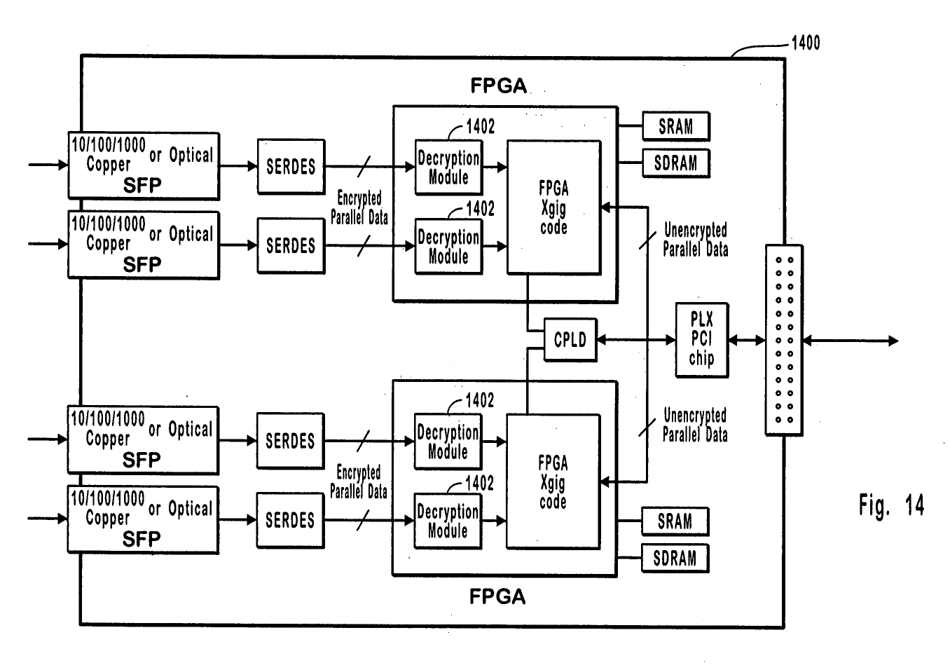

FIG. 14 illustrates that embodiments of the invention may be implemented by using a Finisar Xgig blade 1400. The embodiment of FIG. 14 implements an Xgig blade 1400 using encryption modules 1402.

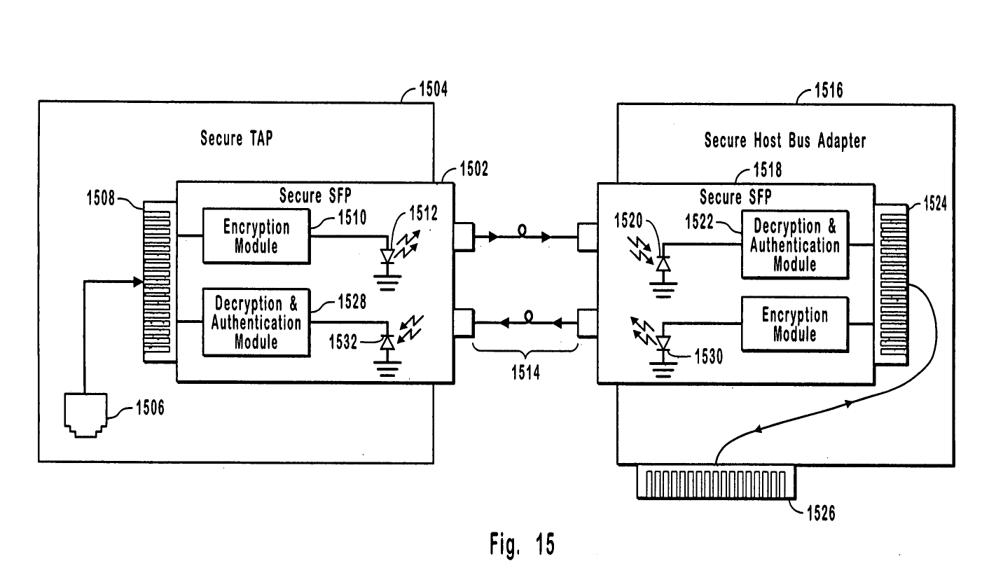

Referring now to FIG. 15, embodiments of the present invention may utilize secure SFP modules to implement a secure network traffic distribution device and a secure NIC. FIG. 15 shows a first secure SFP module 1502 implemented in a secure tap 1504. The secure tap 1504 includes, in this example, a network port 1506 for receiving network traffic. The network port 1506 is connected, through various electrical connections in the secure tap 1504, to an edge connector 1508 that is an interface portion of the secure SFP module 1502. The network traffic, in the form of an electronic signal, is passed to an encryption module 1510. The encryption module 1510 includes a hardware embedded encryption key and logic designed to encrypt the network traffic. The encrypted network traffic, which at this point is still an electronic signal, is fed into a laser diode 1512. The laser diode 1512 converts the encrypted electronic network traffic to an optical signal that is transmitted on a secure link 1514.

The encrypted optical signal is sent to a secure host bus adapter 1516. The secure host bus adapter 1516 includes a second secure SFP module 1518. The second secure SFP module 1518 includes a photodiode 1520 that receives the encrypted optical signal and converts it to an encrypted electrical signal. The encrypted electrical signal is fed into a decryption and authentication module 1522 that includes a hardware embedded key matched to the hardware embedded key of the first secure SFP module 1502. The decryption and authentication module 1522 also includes logic to decode the encrypted electrical signal into the network traffic that was originally captured by the secure tap 1504. The unencrypted network traffic may then be sent through an interface, such as an edge connector 1524 that interfaces the second secure SFP module 1518 to the secure host bus adapter 1516. The secure host bus adapter 1516 can then route the network traffic through an interface such as a PCI interface 1526, to a host device such as an IDS, network analyzer and the like.

The encryption module 1510 and decryption and authentication module 1522 may incorporate logic, including encryption algorithms, embodied in chips produced by LayerN of Austin, Tex. Authentication of the secure tap 1504 and secure host bus adapter 1516 may be accomplished by authentication logic in the decryption and authentication module 1522 of the second secure SFP module 1518 and a decryption and authentication module 1528 in the first secure SFP module 1502.

Policing of the secure link may be accomplished using digital diagnostic logic contained in the first and second secure SFP modules 1502, 1518. For example, the secure SFP modules may contain appropriate hardware and software for monitoring power on the secure link. Alternatively, the digital diagnostics may monitor other characteristics such as hardware encoded encryption keys and the like. Digital diagnostic information can include details of the specific functioning of components within SFP modules 1502, 1518 such as laser diodes 1512, 1530 and the photodiodes 1520, 1532. A memory stored on the SFP modules 1502, 1518 may include various parameters such as but not limited to the following:
Setup functions. These generally relate to the required adjustments made on a part-to-part basis in the factory to allow for variations in component characteristics such as laser diode threshold current.
Identification. This refers to information identifying the optical module type, capability, serial number, and compatibility with various standards. While not standard, additional information, such as sub-component revisions and factory test data may also be included.
Eye safety and general fault detection. These functions are used to identify abnormal and potentially unsafe operating parameters and to report these to a host and/or perform laser shutdown, as appropriate.
Temperature compensation functions. For example, compensating for known temperature variations in key laser characteristics such as slope efficiency.
Monitoring functions. Monitoring various parameters related to the optical module operating characteristics and environment. Examples of parameters that may be monitored include laser bias current, laser output power, receiver power levels, supply voltage and temperature. Ideally, these parameters are monitored and reported to, or made available to, a host device and thus to the user of the optical module.
Power on time. The optical module's control circuitry may keep track of the total number of hours the optical module has been in the power on state, and report or make this time value available to a host device.
Margining. “Margining” is a mechanism that allows the end user to test the optical module's performance at a known deviation from ideal operating conditions, generally by scaling the control signals used to drive the optical module's active components.

Other digital signals. A host device may configure the optical module so as to make it compatible with various requirements for the polarity and output types of digital inputs and outputs. For instance, digital inputs are used for transmitter disable and rate selection functions while outputs are used to indicate transmitter fault and loss of signal conditions. The configuration values determine the polarity of one or more of the binary input and output signals. In some optical modules, these configuration values can be used to specify the scale of one or more of the digital input or output values, for instance by specifying a scaling factor to be used in conjunction with the digital input or output value.

While these digital diagnostic values may be used to optimize performance of the SFP modules 1502, 1518, they may also be used as a “digital fingerprint” for verifying the identity of a particular SFP module. Thus, secure connections can be implemented using various digital diagnostic parameters.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of establishing a secure point to point link comprising:
initiating a trusted link by authenticating a trusted partner;
encrypting data to be sent on the trusted link;
sending the encrypted data on the trusted link;
policing the trusted link by verifying that the trusted partner remains connected to the trusted link and that other un-trusted clients are not connected to the trusted link; and
if the trusted partner becomes disconnected from the trusted link or if an un-trusted client is connected to the trusted link, ceasing to send the encrypted data on the trusted link.

2. The method of claim 1, wherein the data is packetized data including a header and a payload, wherein encrypting comprises encrypting both the header and the payload.

3. The method of claim 1, wherein policing comprises monitoring a signal power on the trusted link.

4. The method of claim 1, wherein policing comprises periodically authenticating the trusted partner.

5. The method of claim 1, wherein authenticating is performed when a trusted partner is first attached.

6. The method of claim 1, wherein authenticating comprises sending and receiving authentication information on an out of band data link.

7. The method of claim 1, wherein encrypting comprises scrambling the network traffic using a hardware embedded encryption key.

8. The method of claim 1, wherein encrypting comprises:
generating a random or pseudorandom encryption key a hardware embedded encryption key; and
scrambling the network traffic using the random or pseudorandom encryption key.

9. A secure network interface device for use in a secure point to point link, the network interface device comprising:
a first interface for receiving encrypted network traffic;
logic for decrypting the encrypted network traffic coupled to the first interface,
wherein the logic comprises a hardware embedded encryption key matched to a network device that sends the encrypted network traffic; and
a second interface coupled to the logic and a host for delivering the decrypted network traffic to the host device.

10. The secure network interface device of claim 9, wherein the second interface is at least one of a USB connector and IEEE 1394 connector.

11. The secure network interface device of claim 9, embodied as a host bus adapter wherein the second interface is a PCI bus connection.

12. A secure network traffic distribution device for use in a secure point to point link, the secure network traffic distribution device comprising:
an input configured to receive network traffic;
an encryption module coupled to the input, the encryption module comprising a first hardware embedded encryption key used to encrypt network traffic, the first hardware embedded encryption key matched to a device that is configured to receive encrypted network traffic from the secure network traffic distribution device; and
an output port coupled to the encryption module, the output port configured to transmit encrypted network traffic.

13. The secure network traffic distribution device of claim 12, embodied as a secure tap wherein the input comprises first and second network ports wherein the first and second network ports are configured to pass through network traffic from each other.

14. The secure network traffic distribution device of claim 12, embodied as at least one of a secure switch, router and hub, further comprising a decryption module coupled to the input port configured to decrypt encrypted network traffic, the decryption module comprising a second hardware embedded encryption key used to decrypt encrypted network traffic, the second hardware embedded encryption key matched to a device that is configured to send encrypted network traffic to the secure network traffic distribution device

15. The secure network traffic distribution device of claim 14, the first and second hardware embedded encryption keys having the same value.

16. The secure network traffic distribution device of claim 12, comprising:
a plurality of input ports configured to receive network traffic;
a plurality of output ports coupled to the encryption module and configured to transmit encrypted network traffic, each output port of the plurality of output ports corresponding to an input port of the plurality of input ports.

17. The secure network traffic distribution device of claim 12, comprising:
a plurality of input ports configured to receive network traffic;
logic to combine network traffic from each of the plurality of input ports; and
wherein the output port is configured to output encrypted network traffic comprising network traffic combined by the logic.

18. The secure network traffic distribution device of claim 12, comprising:
a fanout buffer coupled to the encryption module;
a plurality of output ports coupled to the fanout buffer for providing multiple copies of encrypted network traffic.

19. The secure network traffic distribution device of claim 12 further comprising a management port, the management port coupled to the encryption module and adapted to couple to a management computer, wherein the hardware embedded encryption key is updateable by a management computer coupled to the management port.

20. The secure network traffic distribution device of claim 12 further comprising:
a packet distribution machine coupled to the input port to receive network traffic;
a plurality of queues coupled to the packet distribution machine, the packet distribution machine, in response to a type of network traffic packet, configured to select a corresponding queue from among the plurality of queues; and
a plurality of output ports, each output port coupled to at least one of a queue from among the plurality of queues.

21. The secure network traffic distribution device of claim 20, the packet distribution machine configured to route packets according to at least one of protocol, packet size, and error packets.

22. The secure network traffic distribution device of claim 12, comprising authentication logic configured to authenticate a trusted partner by using out of band data.

23. The secure network traffic distribution device of claim 22, further comprising an authentication connection coupled to the authentication logic and configured to transmit out of band data to the trusted partner.

24. The secure network traffic distribution device of claim: 22, the authentication logic configured to transmit out of band data by modulating a physical layer that transmits network traffic.

25. A secure tap comprising:
an input configured to receive network traffic;
an encryption module coupled to the input, the encryption module comprising a first hardware embedded encryption key used to encrypt network traffic, the first hardware embedded encryption key matched to a device that is configured to receive encrypted network traffic from the secure tap; and
an output port coupled to the encryption module, the output port configured to transmit encrypted network traffic.
